(19) United States
(12) Patent Application Publication
(10) Pub. No.: US 2021/0190261 A1
(43) Pub. Date: Jun. 24, 2021

(54) CAMERA AND RIFLE SHOOTING TRIPOD WITH TENSION-CONTROLLED SWIVIL BASE AND BI-DIRECTIONAL LEG ANGLE LOCKING SYSTEM

(71) Applicant: Vince S Warner, Alpine, UT (US)

(72) Inventor: Vince S Warner, Alpine, UT (US)

(21) Appl. No.: 17/129,835

(22) Filed: Dec. 21, 2020

Related U.S. Application Data
(60) Provisional application No. 62/950,666, filed on Dec. 19, 2019.

(51) Int. Cl. F16M 11/32; F16M 11/04

(52) U.S. Cl. CPC F16M 11/32; F16M 11/04; F16M 2200/06; F16M 2200/021; F16M 2200/08

(57) ABSTRACT

A tripod system features a bowl-top with both static leveling locking capability and with fluid-feel dynamic bowl disk motion. The tripod may feature a precision tension-controlled locking handle with a fine pitch thread screw for more precise tension control and increased holding force and that may be a spring-loaded locking handle to precisely tension adjust the friction force of a tripod top bowl disk to a desired setting, with sufficient tension force to secure a payload even with an offset load. Stability is further increased with a bi-directional leg angle locking system centered about the top hub of the tripod utilizing jam nuts threadedly engaged with the leg heads and allowing or arresting free motion of a ratcheting lock tooth interfacing with the hub.

### CROSS-REFERENCES TO RELATED APPLICATIONS

This application claims priority under 35 U.S.C. § 119(e)(3) as a non-provisional perfection of prior filed a U.S. application No. 62/950,666, filed Thursday, Dec. 19, 2019, and incorporates the same herein by reference in its entirety.

### FIELD OF THE INVENTION

The present invention relates to the field of rifle shooting and photography equipment and more particularly relates to a new type tripod featuring a bowl-top and leveling base system assembly with a bi-directional leg angle locking system.

### BACKGROUND OF THE INVENTION

There are three basic camera and shooting type tripods. The first is the traditional “center tube” style tripod which has three legs attached to a main hub and a center tube that penetrates thru the center of the hub and upon which may be attached various types of aiming devices or heads such as ball heads, pan heads, or video heads which are used to articulate an attached object such as a camera, gun, flash unit, light, projector, level, laser, etc. The center tube or the legs are used to adjust elevation while leveling is achieved by adjusting the length of the legs. The second type is a “flat-top” tripod which also has three legs and a main hub, but instead of a center tube it has a flat surface at the top of the hub upon where which may be attached a series of articulating heads or other devices. Elevation and leveling for this type of tripod is achieved only by adjusting the lengths of the legs. Finally, a “Bowl-Top” tripod is like a flat-top tripod except that a concave hemisphere surface or “bowl” of a given radius is fabricated into the top of the main hub. A matching hemispherical disk having an equal convex hemispherical radiused surface is installed into this bowl and can behave as an adjustable sphere, allowing the inserted disk to rotate to any prescribed angle within the available range of motion of the two mating hemispherical parts. Selected heads, such as those described above, may then be attached to this disk. The bowl-top tripod has primarily been used in videography to allow a videographer to quickly level a tripod head relative the horizon when deployed on uneven ground without having to manually adjust the length of the legs. This allows an attached head to be oriented such that the pan rotation axis of the head is precisely set to a vertical azimuth, so that while panning left to right, the camera will stay parallel to the horizon—a critical requirement for producing professional video imagery and panoramic scenes. The bowl disk is generally a member of a complete apparatus commonly referred to as a “leveling base.” A traditional leveling base consists of the aforementioned mating concave bowl disk, a second concave clamp disk, and a third, handle, member. The clamp disk rides on the bottom side of the main hub, pushing against a parallel offset surface that is opposite the tripod bowl surface. The handle has a bolt which passes through an opening formed the clamp disk and in the hub bowl that then connects to a threaded hole in top bowl disk.

In use, once the bowl disk is adjusted, or “leveled” to the desired position, the handle is then twisted to clamp both disks against the mating surfaces of the main hub to prevent the leveling base assembly from any further movement. Once locked, all further articulation of an attached object is achieved by virtue of the functionality, if any, of the attached apparatus. Thus, the industry naming convention of it being a “leveling base”; which is that its sole function of use; is to simply “level” or position the bowl disk to a prescribed fixed orientation.

Furthermore, traditional tripod systems allow tripod legs to lock in the outward direction but are free to collapse in the inward direction. The free-collapsing concept is practical for quick and easy retrieval and ease of mobility. However, tripods are also now being used where both horizontal and vertical loads are being applied, as opposed to just vertical loads, so that the free collapsing feature of the legs sacrifices stability and performance. Shooting guns from tripods is extremely common practice and the tripod must react to large lateral loads under these conditions. Tripods that do not react to these loads are not ideal for use. Far too many tripods have fallen over because of the common free-collapsing leg angle design concept. Some tripods are designed with additional hardware features to prevent this from happening. These systems typically consist of a series of articulating spanners or braces attached to each leg that expand and lock into position and keep the legs spread apart and locked in place. These systems are typically positioned towards to bottom of the legs or towards their middles.

One feature of this invention is a departure from the traditional bowl top/leveling base tripod design in that it eliminates the need to attach an independent articulating head to achieve dynamic motion or articulation of the connected device. Where all other systems utilize a static leveling base that “locks” the bowl disk in place, this design allows the bowl disk to act as a dynamic system which can move freely and precisely by incorporating a “precision tension-controlled” handle with sufficient spring compliance to allow the bowl disk to continuously rotate in the tripod hub bowl in such a fashion as to simulate the smooth motion normally achieved by an attached photographic head device. The spring-loaded handle, combined with proper material selection, material coatings, and the use of the precisely matched top and bottom bowl disk surface, produces dynamic smooth motion that cannot be achieved by other designs.

The use of a highly precision tension-controlled handle system, as opposed to a typical “on/off” leveling base locking handle, also provides the ability to set a very precise tension setting on the bowl/disk assembly. Doing so allows the tension setting to be equal to the friction break/hold point such that a mounted gun or camera can be easily manipulated, without having to loosen or re-adjust the handle tension setting, and thus achieve both smooth dynamic motion as well as a locked holding position with the same tension setting.

The benefits of making the bowl disk function as a dynamic system as opposed to just acting as a leveling base, extends to no longer requiring the addition of a separate articulating device or head in order make movement changes. An added benefit of eliminating the need for a separate head or aiming system is that the entire structure can be much shorter, lighter, stronger, and stiffer. This is beneficial because now a gun, camera, or other mounted devise can attach directly to the bowl disk and not be connected to a separate head, thus eliminating the compliance and springiness that is inherent with bending moments created by offset payloads attached to a tall camera head or tripod center tube. This improved stability greatly enhances the use of the tripod system for stabilizing firearms, heavy long lens cameras, spotting scopes, etc.

The elimination of an added head also offers the benefit of weight reduction. For the mobile outdoor user, elimination of a separate articulating head is a tremendous benefit for keeping the size and total-carry weight of the tripod to a minimum. The center of gravity of the attached payload is also beneficially shifted, thus greatly reducing the tendency of heavy payloads to “flop over” when making movements of the payload, which is inherent in the use of certain head designs such as a “ball head”.

Certainly, the fact that a precision tension bowl disk system capable of dynamic motion does not preclude it from also behaving as a traditional on-off leveling base with the similar ability to attach and hold any type camera head or other device directly to the bowl disk and achieve the same capabilities.

This invention also utilizes a bi-directional tripod leg angle lock system that is a complete departure from the concepts used in the prior art. No tripod designs exist where the bi-directional leg angle locking function is achieved at the hub-leg hinge point in the fashion used in this invention. Outward motion leg angle lock is traditionally accomplished at the leg hinge location, but an inward lock is not. This invention achieves both an automatic closing with the usual outward lock function but also offers an optional inward locking functionality at each angle lock position, all achieved at the tripod leg hinge joint location. The benefit of having bi-directional leg angle locking function achieved at this location is that it is much easier to use and deploy, generally less expensive to manufacture and with far fewer parts, much smaller by design, lighter to carry, and it provides other enhanced performance features not available in the existing spanner type leg lock designs. One such feature is the inherent strength enhancement added to the leg hinge point hardware. The “jam nut” used to lock leg angle also forces the mating components of the leg hinge hardware to their limit of travel built into the hinge joint manufacturing clearances typically used in tripod design. These clearances, by virtue of the jam nut design, are pressed to the clearance limits thus closing all the clearance gaps and create a metal-to-metal contact of all affected components, thus creating yet an even more robust joint connection not possible with other tripod designs.

### SUMMARY OF THE INVENTION

In view of the foregoing disadvantages inherent in the known leveling base bowl-top type tripod systems, leg angle locking systems, and leg hinge joints gaps, the advantages of an improved precision tension controlled dynamic bowl type tripod with a bi-directional leg angle locking system may meet the following objectives: that it be easy to construct and implement; that it provides greater stability to a supported object, even under lateral loads; that it provides fine adjustment control to the supported object; that be able to adjust within a large arc range for maximal leveling capability; that is inherently more stable due to a lower center of gravity; that it has less compliance when reacting offset loads due to it being sorter in height; that the reduction of required elements will be smaller and lighter to carry; that the legs be lockable in both inward and outward directions; that engaging the leg angle lock system also stiffens the leg hinge joint mechanism; that said locking mechanism be simple and intuitive to use. As such, to accomplish these objectives, a new and improved tripod system may comprise a precision tension adjustable bowl support, proper material selection with dynamic sliding surfaces, and a bi-directional locking tooth interface between the legs and tripod hub.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of one embodiment of a tripod.

FIG. 2 is a top plan view of the tripod of FIG. 1.

FIG. 3 is a sectional view of the tripod of FIG. 2, taken along line III-Ill.

FIG. 4 is a partially exploded view of the tripod of FIG. 3, focusing on the bowl-top control system.

FIG. 5 is a perspective view of a fingered support cup for use in a second embodiment of the tripod of FIG. 1.

FIG. 6 is a side elevation of the fingered support cup of FIG. 5.

FIG. 7 is a sectional view of another embodiment of a tripod using the support cup of FIG. 5, in the same view as FIG. 3.

FIG. 8 is a partially exploded view of the tripod of FIG. 7.

FIG. 9 is a partially exploded view of the leg locking system of the tripod shown in FIG. 3.

FIG. 10 is the tripod of FIG. 3, with the leg locking system fully disengaged.

FIG. 11 is the tripod of FIG. 3, with the leg locking system partially disengaged.

### DETAILED DESCRIPTION OF THE PREFERRED EMBODIMENT

With reference now to the drawings, a preferred embodiment of the tripod is herein described. It should be noted that the articles “a”, “an”, and “the”, as used in this specification, include plural referents unless the content clearly dictates otherwise.

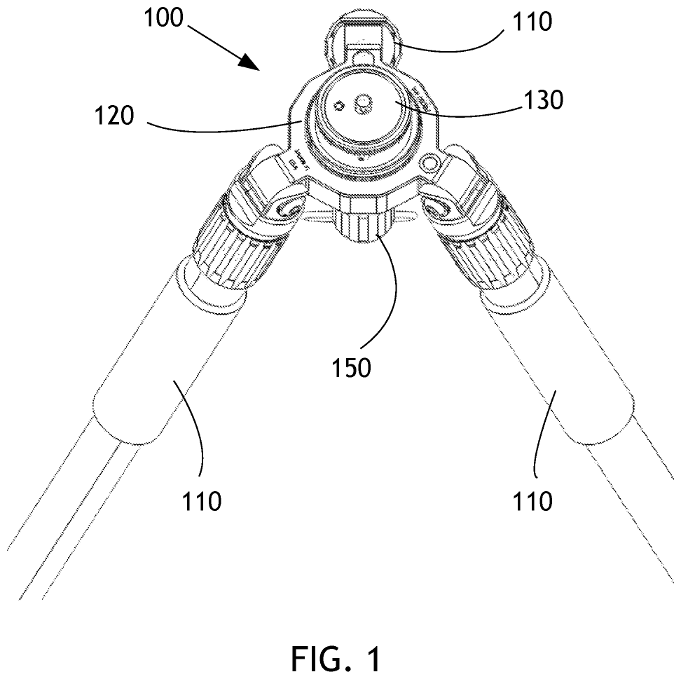

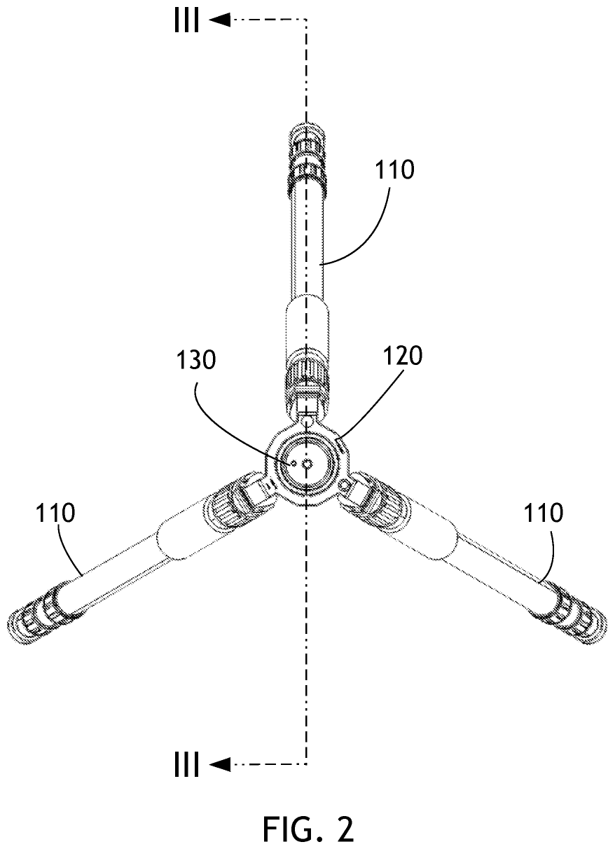

With reference to FIGS. 1-4, the tripod 100 features three legs 110 attached to a central hub 120 at arm 124. A disk 130 resides in the central hub 120. Precision handle 150 penetrates thru clamp disk 140 and thru springs 142 and attaches to mounting bolt 132 and interfaces with bowl disk 130 to tighten bowl disk 130 and clamp disk 140 against the central hub 120, locking the bowl disk 130 in place.

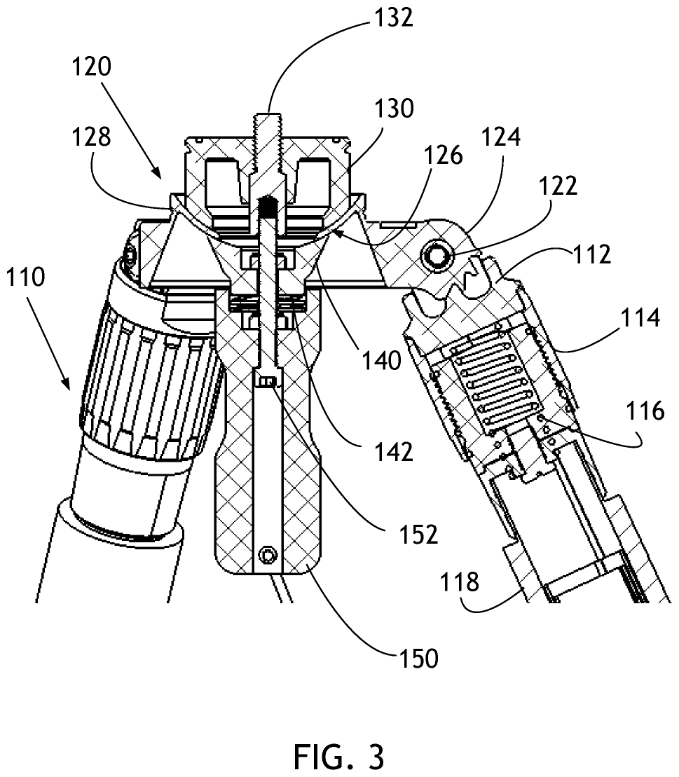

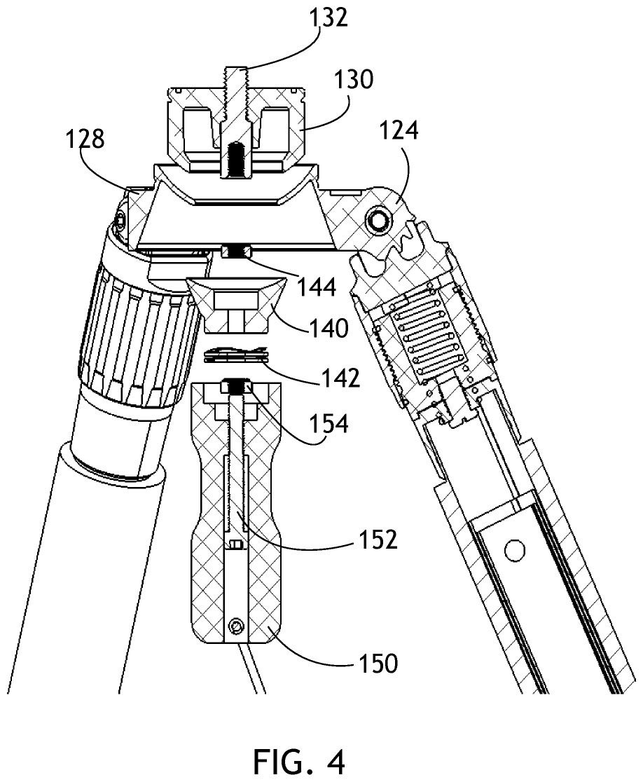

As shown more specifically in FIGS. 3 and 4, bowl disk 130 more particularly resides within a bowl 126 fashioned in the hub body 128 and features a central mounting bolt 132 for a supported object or any adapters for such objects. Clamp disc 140 features a bowl top which interfaces with the hemispherical bottom surface of the central hub's bowl 126. Bowl 126 features an incomplete bottom surface through which handle 150 may attach to bowl disk 130 with its bolt 152 through clamp disk 140. For simplicity, bolt 152 may fasten into a threaded receiving end of central mounting bolt 132. Locking nuts 154, 144 may be provided to help secure the bolt 152 in place. A highly compressive spring or other compliant member 142 is also provided between the handle 150 and clamp disk 140 to provide tension and separation distance between the clamp disk 140 and handle 150 when the handle is loosened or tightened. The compressive spring 142 may take any form, including but not limited to the stack of spring washers in cooperation with flat washers depicted in the figures. To adjust the bowl disk 130, the handle 150 is loosened, increasing the spacing between clamp disk 140 and handle 150 thus decreasing the spring tension of clamp disk 140 and bowl disk 130 on to the hub 120. Once adjusted, the handle 150 may be set to a prescribed tension setting or completely tightened to fully locked position. The presence of the compressive spring 142 allows for the clamp disk 140 and bowl disk 130 to have a minimum separation from the hub 120, so that the static friction between them may be easily set to a precise break-away point if intended such that very small external input will allow bowl disk to move freely as commanded yet still hold an attached payload in a static position. The use of a fine pitch on bolt 152 also allows for controlled release of the handle 150 and the associated locking force between clamp disk 140 and hub 120. The fine pitch thread also produces increased holding force on bowl disk 130. Material selection and surface treatment of clamp disk 140 and hub 120 is essential to achieve smooth dynamic motion. A non-metallic material with a very low coefficient of friction such as nylon or DELRIN for clamp disk 140 proved to be helpful for precise, smooth, dynamic motion.

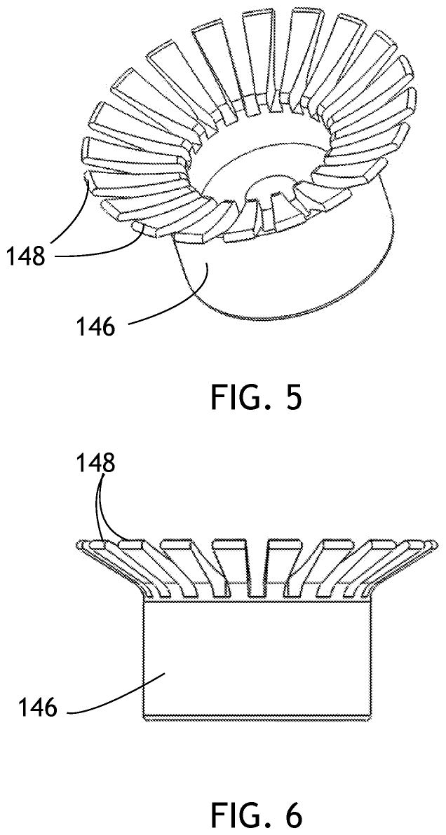

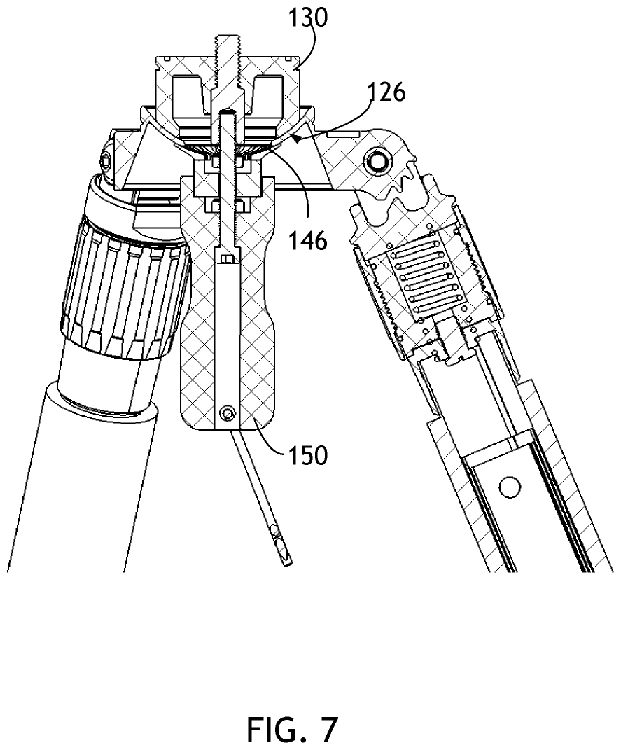

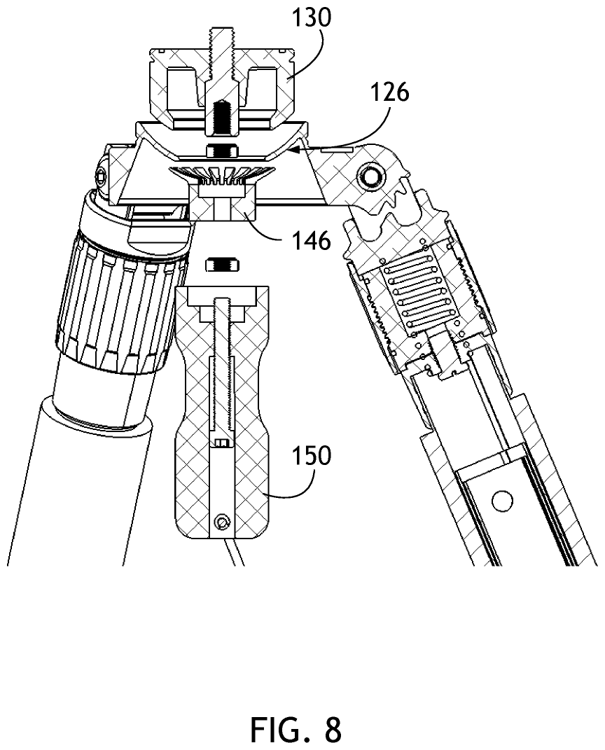

One alternate embodiment features an integrated clamp disk and compressive spring 146, shown in FIGS. 5 and 6. The alternate clamp disk 146 features a bowl top with a multitude of fingers 148 forming its bowl. The alternate compressive spring 146 is made of a resilient material, such as metal or polymer, and may be manufactured of nylon or DELRIN. This resilience allows the fingers 148 sufficient flexibility to serve as the compliant member and provide compressive force on the bowl 126 when the handle 150 is tightened or loosened, as described in the previous embodiment. As shown in FIGS. 7 and 8, the single clamp disk 146 replaces both the original clamp disk 140 and compressive spring 142 in the system.

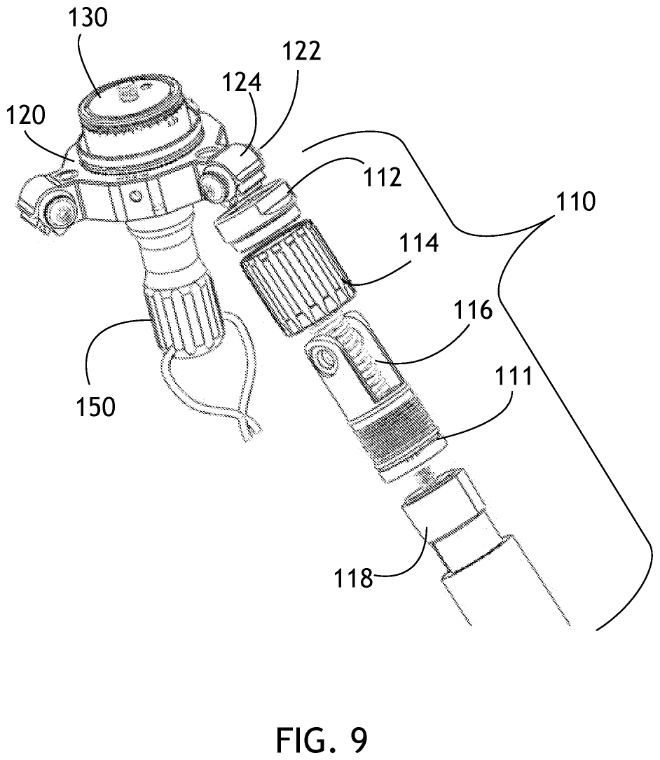

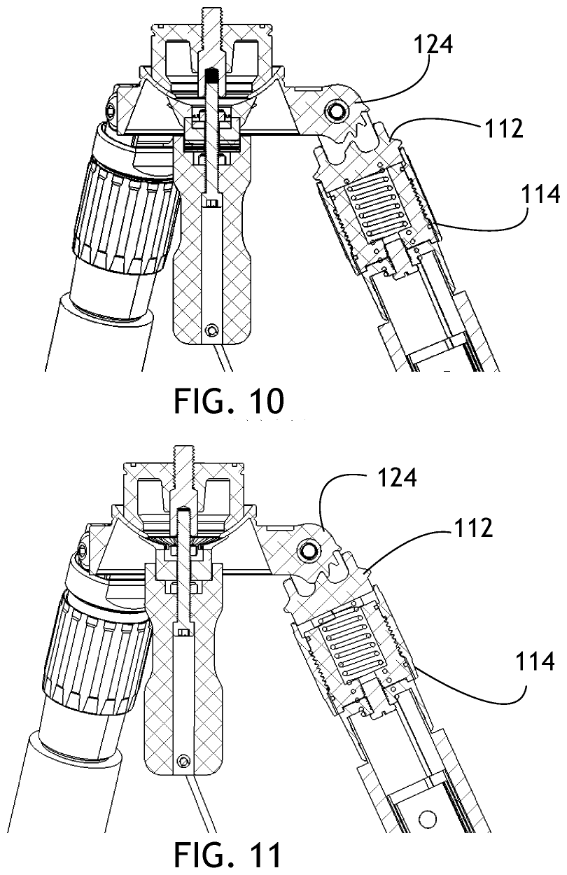

As seen in FIGS. 3 and 9, each leg 110 features a leg body 118 attached to a head 111, possibly by a threaded interface. Adjustment tooth 112 is spring biased into a closed position. Each leg 110 is pivotably mounted 122 at its head 111 upon the central hub 120 at an arm 124 extending from the hub body 128. The adjustment tooth 112 selectively interfaces with a plurality of teeth on the arm 124 and are preferred to be angled in a manner to allow ratcheting between the teeth. Depressing the adjustment tooth 112 against the bias spring 116 releases the tooth from its engagement and allows adjustment of the legs. However, jam nuts 114 are positioned underneath the adjustment teeth 112 and are threadingly engaged with the head 111. When tightened, as shown in FIG. 3, the jam nuts 114 prevent actuation of the adjustment teeth 112 and hold the legs 110 in position rigidly against both vertical and horizontal forces. The jam nuts 114 may be loosened which will allow an adjustment tooth 112 to be depressed and free the legs for motion (FIG. 10) or may be held by spring pressure against the arm 124 and allow only inward motion due to a ratcheting relationship between the teeth (FIG. 11).

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A tripod comprising:
a central hub, said central hub further comprising:
a hub body;
a bowl depression within the hub body having a hemispherical outer surface; and
three mounting arms extending from the central hub;
a bowl disk positioned within the bowl depression and having structure for mounting an object;
a lock disk having a bowl top and positioned underneath the bowl depression and abutting the hemispherical outer surface;
a tensioning handle, connected to the bowl disk by a tensioning bolt passing through the lock disk and central hub;
a compliant member; and
three legs, one mounted upon each of the three mounting arms.

2. The tripod of claim 1, the tensioning bolt having a fine thread allowing for precise adjustment.

3. The tripod of claim 1, the compliant member being a spring located between the lock disk and the tensioning handle.

4. The tripod of claim 3, the spring being selected from the set of springs consisting of: a plurality of stacked washers and compression springs.

5. The tripod of claim 1, the compliant member being a plurality of fingers forming the bowl top of the lock disk.

6. The tripod of claim 5, the lock disk being comprised of a polymer.

7. The tripod of claim 1, the lock disk being comprised of a polymer.

8. The tripod of claim 1, each leg further comprising:
a leg head attached to a leg body and pivotably attached to one of the three mounting arms;
a lock tooth situated in the head and interacting with the one of three mounting arms;
a jam nut encompassing and threadedly engaged with the leg head such that it selectively abuts the lock tooth;
a compression spring situated within the leg head and jam nut, applying pressure to the lock tooth and biasing it into the one of three mounting arms.

9. The tripod of claim 8, each mounting arm further comprising a plurality of arm teeth with which the lock tooth will selectively engage.

10. The tripod of claim 9, the lock tooth and arm teeth being oriented in a manner to allow ratcheting interaction therebetween when the jam nut is not engaged with the lock tooth.

11. The tripod of claim 10, the ratcheting interaction allowing the legs to collapse inward into a stowed position.

12. A tripod comprising:
a central hub, said central hub further comprising:
a hub body with a central hub;
three mounting arms extending from the central hub; and
three legs, one mounted upon each of the three mounting arms and each leg further comprising:
a leg head attached to a leg body and pivotably attached to one of the three mounting arms;
a lock tooth situated in the head and interacting with the one of three mounting arms;
a jam nut encompassing and threadedly engaged with the leg head such that it selectively abuts the lock tooth.

13. The tripod of claim 12, each mounting arm further comprising a plurality of arm teeth with which the lock tooth will selectively engage.

14. The tripod of claim 13, the lock tooth and arm teeth being oriented in a manner to allow ratcheting interaction therebetween when the jam nut is not engaged with the lock tooth.

15. The tripod of claim 14, the ratcheting interaction allowing the legs to collapse inward into a stowed position.

16. A tripod comprising:
a central hub, said central hub further comprising:
a hub body
a bowl depression within the hub body having a hemispherical outer surface; and
three mounting arms extending from the central hub;
a bowl disk positioned within the bowl depression and having structure for mounting an object;
a lock disk comprised of a polymer and having a bowl top and positioned underneath the bowl depression and abutting the hemispherical outer surface;
a tensioning handle, connected to the bowl disk by a tensioning bolt passing through the lock disk and central hub;
a compliant member; and
three legs, one mounted upon each of the three mounting arms and further comprising:
a leg head attached to a leg body and pivotably attached to one of the three mounting arms;
a lock tooth situated in the head and interacting with the one of three mounting arms;
a jam nut encompassing and threadedly engaged with the leg head such that it selectively abuts the lock tooth.

17. The tripod of claim 16, the tensioning bolt having a fine thread allowing for precise adjustment.

18. The tripod of claim 16, the compliant member being a spring located between the lock disk and the tensioning handle.

19. The tripod of claim 18, the spring being selected from the set of springs consisting of: a plurality of stacked washers and compression springs.

20. The tripod of claim 16, the compliant member being a plurality of fingers forming the bowl top of the lock disk.
